(19) United States
(12) Patent Application Publication
(10) Pub. No.: US 2010/0173675 A1
(43) Pub. Date: Jul. 8, 2010

(54) "Talk-to-talk" telephony, especially mobile telephony

(76) Inventor: Michael J. Ure, Cupertino, CA (US)

Correspondence Address: MICHAEL J. URE, 10518 PHIL PLACE, CUPERTINO, CA, 95014, US

(21) Appl. No.: 12/348,455

(22) Filed: Jan. 5, 2009

(51) Int. Cl. H04B 1/38

(52) U.S. Cl. 455/563; 704/275

(57) ABSTRACT

A “talk-to-talk” (as compared to “push-to-talk,” for example) interface technique is used to establish voice communications. In accordance with one method, a user speaks the name of a desired party. Machine recognition of the name is performed, and a determination is made whether the desired party is unreachable. Unless the desired party is unreachable, packet-based voice communications with are commenced with the desired party. Packet-based voice communications may include sending the name of the desired party as previously spoken, possibly in combination with other words, either spoken or previously recorded. Instant-messaging type presence services may be used to determine whether or not the desired party is unreachable. Typically, the desired party is unreachable when the desired party is not within range of or is not connected to a wireless network such as a WLAN network, a WiMax network, or other IP network or “always on” network.

### TECHNICAL FIELD

The present invention relates to telephony, especially mobile telephony.

### BACKGROUND

U.S. Patent Publication 2007/0217396, incorporated herein in relevant part in Appendix I, describes a technique for making a VoIP (voice over IP) connection through a network using voice recognition. For example, a user may speak into a wireless audio I/O device the words “Call Bob.” A voice recognition module analyzes the meaning of the voice information and consults an electronic directory or phone book in order to establish a VoIP connection.

Further improvements are desired.

### SUMMARY

A “talk-to-talk” (as compared to “push-to-talk,” for example) interface technique is used to establish voice communications. In accordance with one method, a user speaks the name of a desired party. Machine recognition of the name is performed, and a determination is made whether the desired party is unreachable. Unless the desired party is unreachable, packet-based voice communications with are commenced with the desired party. Packet-based voice communications may include sending the name of the desired party as previously spoken, possibly in combination with other words, either spoken or previously recorded. Instant-messaging type presence services may be used to determine whether or not the desired party is unreachable. Typically, the desired party is unreachable when the desired party is not within range of or is not connected to a wireless network such as a WLAN network, a WiMax network, or other IP network or “always on” network.

Talk-to-talk (TTT) Telephony systems and telephony devices are also described.

Additional features and benefits of the present invention will become apparent from the detailed description, figures and claims set forth below.

### BRIEF DESCRIPTION OF THE DRAWINGS

The accompanying drawings, which are incorporated into and constitute part of this specification, illustrate one or more examples of embodiments and, together with the description of example embodiments, serve to explain the principles and implementations of the embodiments.

In the drawings:

FIG. 1 is a block diagram of a known apparatus for making a voice connection.

FIG. 2 is a flow chart of a known dial-out procedure.

FIG. 3 is flow chart of a known call-in procedure.

FIG. 4 is a block diagram of a known apparatus for making a voice connection.

FIG. 5 is a flow chart of a known dial-out procedure of the apparatus.

FIG. 6 is a flow chart of a known call-in procedure of the apparatus.

FIG. 7 is a block diagram of a telephony system.

FIG. 8, including FIG. 8A, FIG. 8B, and FIG. 8C, is a diagram illustrating a use case of the telephony system of FIG. 7.

FIG. 9 is a block diagram of portions of a telephony device.

FIG. 10 is a flow chart of a setup procedure for the present “talk-to-talk” interface technique.

FIG. 11 is a flow chart of an alternative setup procedure for the present “talk-to-talk” interface technique.

FIG. 12 is a flow chart of a “talk-to-talk” interface technique used to establish voice communications.

FIG. 13 is a perspective view of a headset that may be used in the telephony system of FIG. 7.

FIG. 14 is a block diagram a portion of the headset of FIG. 13.

### DESCRIPTION OF EXAMPLE EMBODIMENTS

Example embodiments are described herein in the context of a golf swing training tool that provides a direct visual prompt as to proper club head swing path. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

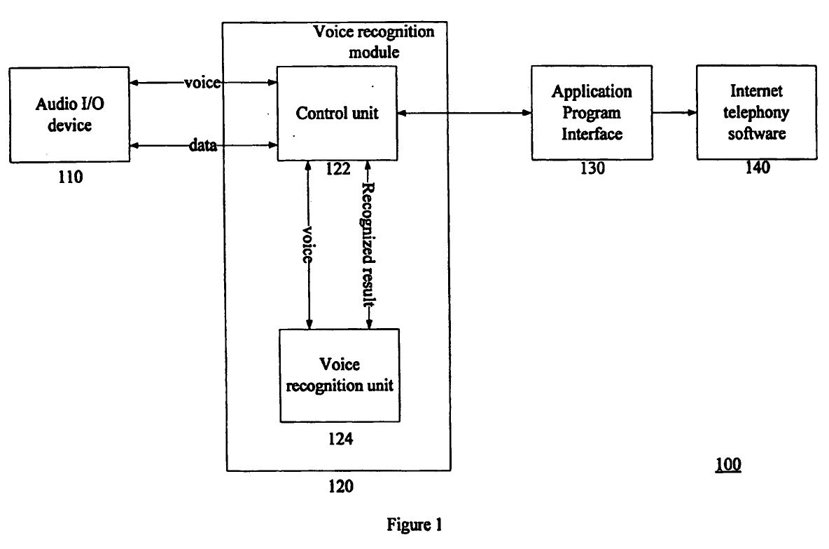

FIGS. 1-6 relate to prior art patent publication U.S. 2007/0217396 and are described in detail in Appendix 1. A fuller appreciation of the present invention may be had by reading Appendix 1 in conjunction with FIGS. 1-6 before proceeding further with the following description.

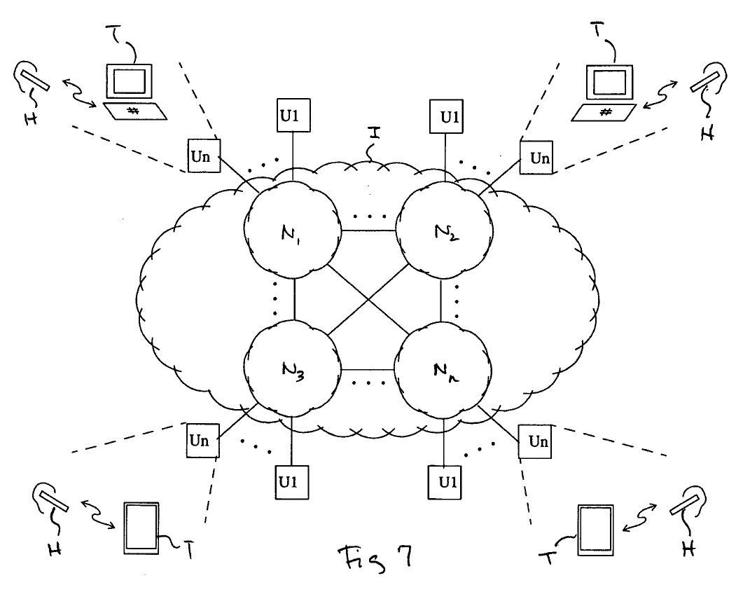

Referring now to FIG. 7, a block diagram of a telephony system in which talk-to-talk telephony may be applied. User equipment of various users is connected to subnets N1-Nn of an IP network I such as the internet, an intranet, etc. In the illustrated embodiment, each subnet connects some number of users U1-Un. The user equipment of each user includes a headset H and a telephony device T. The telephony device T may take the form of a desktop computer, a laptop computer, a mobile electronic device, a smartphone such as the iPhone™ brand smartphone or a WiFi-capable iPod™ music player, both available from Apple, Inc., etc.

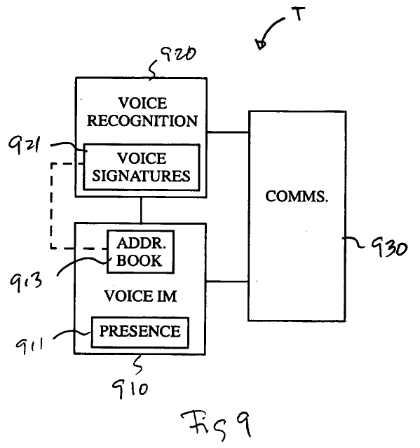

FIG. 9 shows in greater detail portions of a telephony device T of FIG. 7. The telephony device T includes a voice instant messaging unit 910, a voice recognition unit 920, and a communications unit 930. The voice instant messaging unit 910 includes a presence module 910 and an address book module 913 and may take the form of any of various known voice instant messaging packages such as the Google Talk™ package available from Google, Inc., with certain modifications described below. The voice recognition unit 920 may be any of various known voice recognition packages from such vendors as Lerner and Hauspie, Nuance Communications, etc. As described in greater detail below, voice signatures 921 are stored in correspondence to contacts in the address book 913. The communications unit 930 includes commercially available communication “stacks” including, for example, one or more PAN (personal area network) stacks such as a Bluetooth™ stack, a UWB (ultra-wideband) stack, etc., and one or more LAN (local area network) or WAN (wide area network) stacks such as a WiFi™ stack, a WiMax™ stack, etc.

The voice recognition unit 920 may form part of the telephony device T or may be provided in the form of a service available to the telephony device T over the network N.

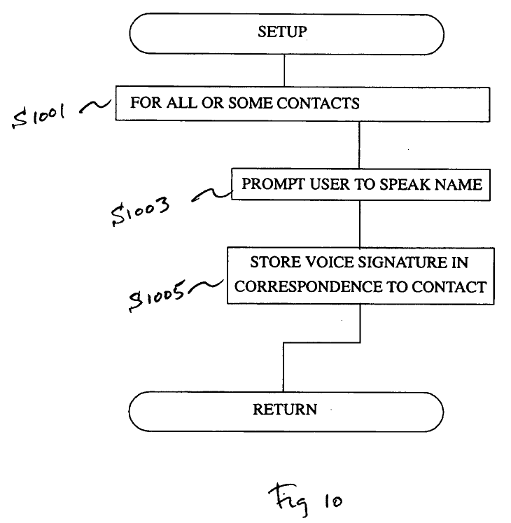

A flow chart of a setup procedure for the present “talk-to-talk” interface technique is shown in FIG. 10. The user operates the telephony device T to perform the setup procedure. Beginning at step S1001, for all or some of the contacts stored in the address book (913), the telephony device T prompts the user to speak the name of the contact (S1003). In step S1005, a voice signature of the name as spoken by the user is stored in correspondence to the contact. The voice signature may be stored locally or may be stored remotely over the network N.

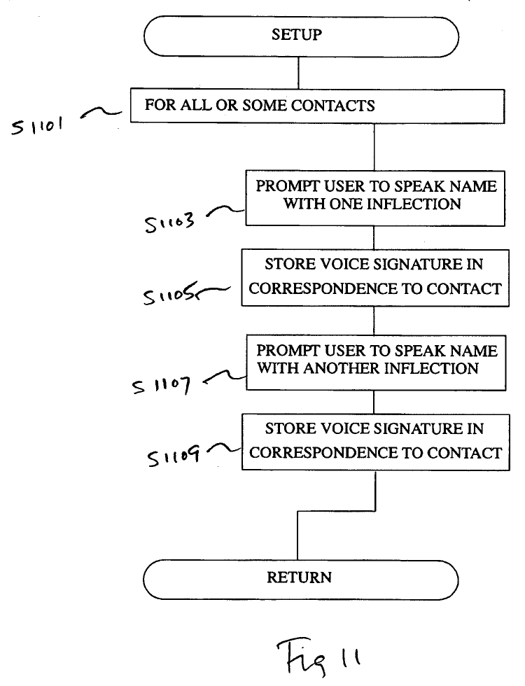

A flow chart of an alternative setup procedure for the present “talk-to-talk” interface technique is shown in FIG. 11. The user operates the telephony device T to perform the setup procedure. Beginning at step S1101, for all or some of the contacts stored in the address book (913), the telephony device T prompts the user to speak the name of the contact using a first inflection (S1103), e.g., a rising inflection typical of a query. In step SI 105, a voice signature of the name as spoken by the user is stored in correspondence to the contact. The voice signature may be stored locally or may be stored remotely over the network N. The telephony device T further prompts the user to speak the name of the contact using a first inflection (S1107), e.g., a falling inflection typical of a declaration. In step S1109, a voice signature of the name as spoken by the user is stored in correspondence to the contact. The voice signature may be stored locally or may be stored remotely over the network N. During talk-to-talk telephony, the user may wish to use different voice inflections at different times, or may unconsciously use one inflection or the other. By storing voice signatures of different inflections during setup, the user is then enabled to use different inflections either intentionally or unintentionally.

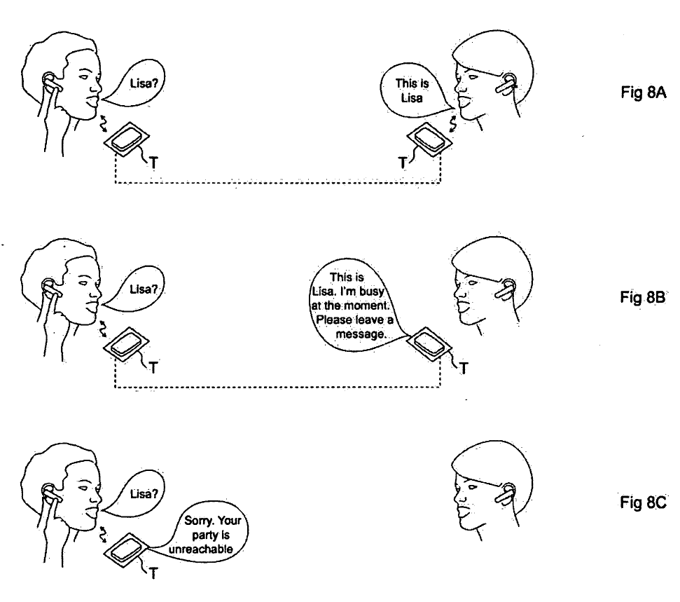

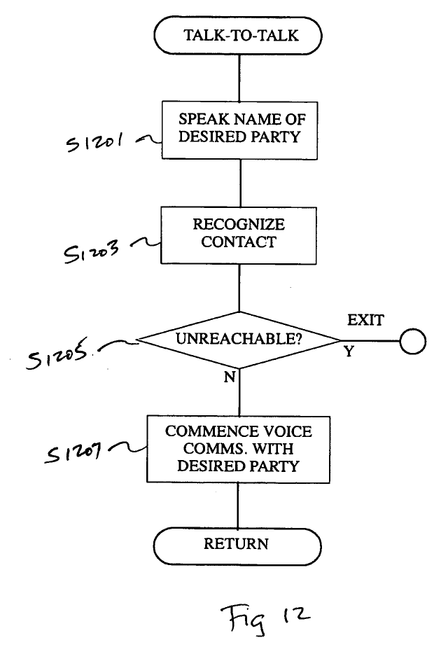

A flow chart of one embodiment of a talk-to-talk interface technique used to establish voice communications is shown in FIG. 12. At step S1201, the user speaks the name of a desired party into a headset H. In one embodiment, the user presses a button or, more preferably, activates a touch sensor, to create a wakeup event that alerts the headset to expect voice input. In step S1203, voice recognition is performed with respect to the voice input in order to recognize a contact corresponding to the desired party. A determination is then made, using the presence module 911, if the desired party is unreachable (S1205). If the desired party is unreachable, the routine exits after alerting the user, for example by way of a recorded voice message or other recognizable aural signal. Assuming the desired party is not found to be unreachable (S1207), the telephony device T commences voice communications with the desired party, for example by sending an audio representation of the name as spoken by the user. The voice instant messaging module 910 may differ from known voice instant messaging packages in this immediacy of voice communications, without the need for ringing or call alert and, at least in some instances, without the need for the desired party to perform any affirmative action to answer a call other than speak in reply. This difference may be illustrated by considering the use cases illustrated in FIGS. 8A-8C.

In FIG. 8A, a caller Mike activates his headset and speaks the name of a desired party, in this instance Lisa. Lisa's telephony device is assumed to be connected to the network N so that Lisa is not unreachable. Mike's telephony device therefore commences voice communications with Lisa's telephony device, for example by sending an audio representation of Lisa's name as spoken by Mike.

In one embodiment, Lisa hears her name as spoken by Mike even if Lisa is involved in another call (but the other party involved in Lisa's call preferably does not). Lisa will likely recognize the voice of the caller, such that caller identification will often be implicit. If she is not involved in another call, Lisa may either simply reply (for example, “This is Lisa”) or, depending on device settings, activate her headset to open the microphone of the device and then reply. In one embodiment, the user is able to select for each contact whether calls from that contact will be immediately received (i.e., the mic will be open immediately) or whether some affirmative action is required to open the mic.

Referring to FIG. 8B, if Lisa is involved in another call or if her telephony device is set to do not disturb, etc., depending on device settings, Lisa may or may not hear her name spoken. In any event, Lisa does not herself reply. Instead, her telephony device plays a recorded message, e.g., “This is Lisa. I'm busy at the moment. Please leave a message.”

In FIG. 8C, Mike speaks Lisa's name, but the presence module 911 of the voice instant messaging unit 910 of Mike's telephony device determines that Lisa is unreachable (i.e., that Lisa's telephony device is not connected to the network). Mike is alerted, for example by way of a recorded voice message (e.g., “Sorry. Your party is unreachable.”) or other recognizable aural signal.

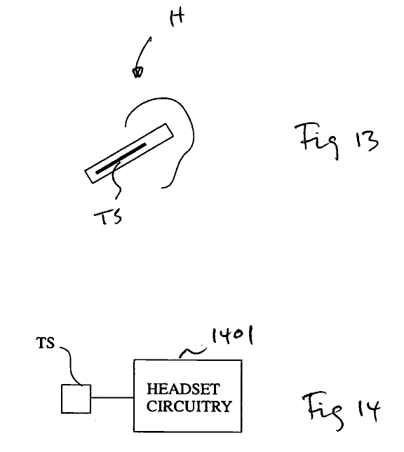

Known headsets use a single-button or multi-button interface. The present talk-to-talk interface may be used with these existing device interfaces. Alternatively, a headset may be provided having a touch sensor interface instead of or in addition to a button interface. Such a headset H having a touch sensor TS is illustrated in FIG. 13. In some instances, the capability may be provided for the touch sensor to distinguish between different touches (e.g., one finger, two finger, etc.). A block diagram of a portion of the headset H of FIG. 13 is shown in FIG. 14. The touch sensor TS is coupled to headset circuitry 1401.

Various touch gestures, including single-touch and multi-touch gestures, may be defined to enable a more versatile interface. For example, touch gestures may be defined for the usual ON, OFF and VOLUME functions. Additionally, touch gestures may be defined to, for example, join an incoming call to a current call, place a current call on hold, reactivate a call previously placed on hold, record all or part of a call, create a voice memo, etc.

While embodiments and applications have been shown and described, it would be apparent to those skilled in the art of having the benefit of this disclosure that many more modifications than mentioned above are possible without departing from the inventive concepts disclosed herein. The invention, therefore, is not to be restricted except in the spirit of the appended claims.

### Appendix 1

The following description is taken from U.S. Patent Publication 2007/0217396.

Please refer to FIG. 1 which is a block diagram of an apparatus, such as a voice recognition module 120, for making a voice connection, such as a VoIP connection, through a network, such as the Internet. The voice recognition module 120 comprises a voice recognition unit 124 for analyzing received first voice information and generating a recognized result; and a control unit 122, coupled to the voice recognition unit 124, for establishing the voice connection through the network according to the recognized result.

The apparatus for establishing a voice connection may further comprises at least one of audio I/O device 110, Application Program Interface (API) 130, and network telephony software 140. Alternatively, the network telephony software 140 may be one of the Internet telephony software, such as Skype. Therefore, we take Skype as an example in the following paragraphs. It should be noted that the network telephony software 140 could be MSN, Google Talk, or other VoIP software. In the present embodiment, the audio I/O device 110 could be a wired telephone device or a microphone electrically coupled to the voice recognition module 120. The audio I/O device 110 provides voice information to the voice recognition module 120 in which voice recognition unit 124 is utilized for analyzing the received voice information and then generating a recognized result accordingly. The control unit 122 is further utilized for propagating voice information and controlling the operation of the network telephony software 140 according to the recognized result. In another embodiment, the control unit establishes a second voice connection through another IP or phone number (such as mobile phone number) when the voice connection through the network cannot be established. Additionally, the API 130 may be an open source announced by the development team of Skype allowing other application program access the services of Skype.

An exemplary method for establishing a voice connection through a network comprises the steps of receiving voice information; analyzing the voice information and generating a recognized result; and establishing the voice connection through the network according to the recognized result.

The voice connection may be a single voice connection (one-to-one voice connection) or a group of voice connection (one-to-multiple voice connection) and may be established by one of network telephony software comprising Skype, MSN, Google Talk, and VoIP software.

Another exemplary method for establishing a voice connection through a network further comprises the step of providing a first default voice message when receiving a connection signal from an audio I/O device. A method for establishing a voice connection through a network may further comprise the step of determining at least one IP or phone number corresponding to the voice information according to the recognized result.

A method for establishing a voice connection through a network may further comprise the step of establishing a second voice connection, automatically or according to a user's selection, through another IP or phone number when the voice connection through the network cannot be established.

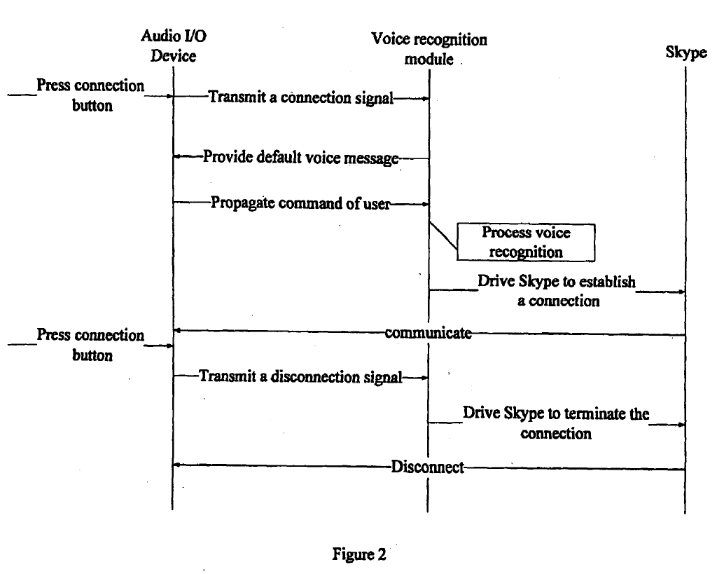

Referring to FIG. 2, FIG. 2 is a flow chart of a dial-out procedure. If the audio I/O device 110 receives an voice information asking to establish a voice connection to a specific person (or a group of specific persons) from a user, the audio I/O device 110 transmits the voice information to the control unit 122, and the control unit 122 passes the voice information to the voice recognition unit 124 for analyzing the meaning of the voice information and then determining at least one of the IP(s) or phone number(s) of the specific person(s) according to the recognized result and a phone book of the network telephony software 140 (e.g., Skype). For example, if the voice information means “call Bob,” the control unit 122 inquires the phone book of Skype, and finds out at least one IP or phone number of Bob for establishing a voice connection (such as VoIP connection) through the API 130. If the connection is established successfully, the control unit 122 is in charge of propagating voice information between the audio I/O device 110 and the network telephony software 140. However, if the connection cannot be established, the control unit 122 is capable of drive the network telephony software 140 to dial a phone number of the specific person by performing a service, such as Skype-out, automatically or according to a user's selection. However, if there is no phone number of the specific person recorded or the specific person is not available, the control unit 124 may drives the audio I/O device 110 to play a voice message replying the user that the connection cannot be established.

For saving power or meeting certain design considerations, the user can press a connection button on the audio I/O device 110 before saying the command in the present embedment. Once the connection button is pressed, the audio I/O device 110 transmits a connection signal to the control unit 122 and then the control unit 122 transmits a default voice message to the audio I/O device 110 for asking user's voice commands. Afterward, the control unit 122 is ready to receive the voice information or command from the audio I/O device 110 and drives Skype to establish a voice connection. When the user would like to disconnect the connection, the user may press the connection button of the audio I/O device 110 again so as to transmit a disconnection signal to the voice recognition module 120 to drive the Skype to terminate the connection.

According to one embodiment, a method for receiving a voice call through a network comprises the steps of identifying the received voice call through the network and providing a voice information indicating the calling party; getting through the voice call upon a user's command or providing a voice message asking the calling party to leave voice message according to the user's setting. According to another embodiment, the method further comprises the step of playing at least one left voice message upon the user's request.

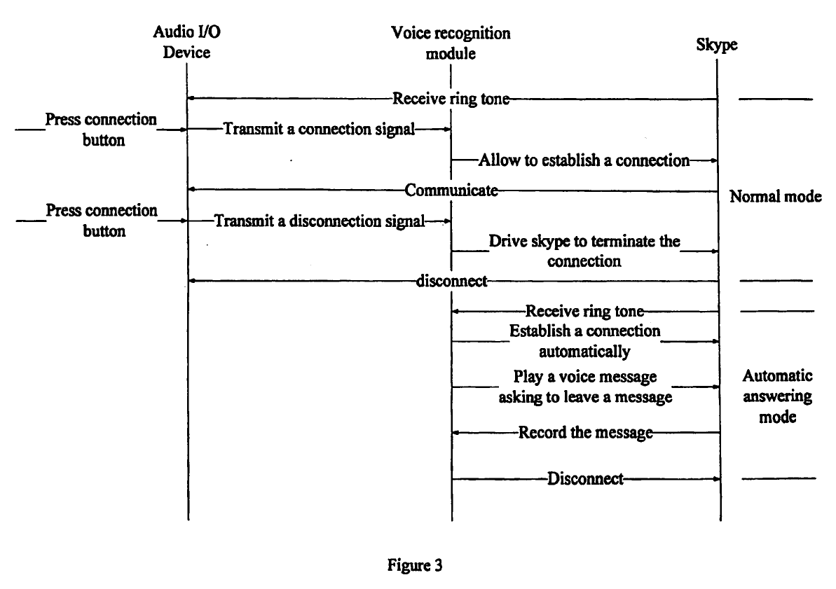

FIG. 3 is flow chart of a call-in procedure of the apparatus. If the computer or phone device on the other side would like to establish a voice connection, the control unit 122 may identify the received voice connection according to the phone book of Skype and then provide the Audio I/O device 110 with voice information indicating the calling party. If the calling party cannot be identified, the control unit 122 may directly provide the audio I/O device 110 with the ring tone. After the user presses the connection button on the audio I/O device 110, the voice connection is established and the voice information of the user or the calling party is propagated through the audio I/O device 110, the control unit 122, API 130 and the network telephony software 140 and the computer or phone device of the calling party. In other words, the user is capable of talking to the calling party after pressing the button. If the user is busy or the user would not like to answer the predetermined calling party, the control unit 122 may provide a voice message asking the calling party to leave voice message according to the user's setting. The message recorded by the control unit 122 is then played upon the user's request. When the user would like to hear the recorded message, the control unit 122 would play voice massage asking the user to select, play, repeat or delete the recorded messages.

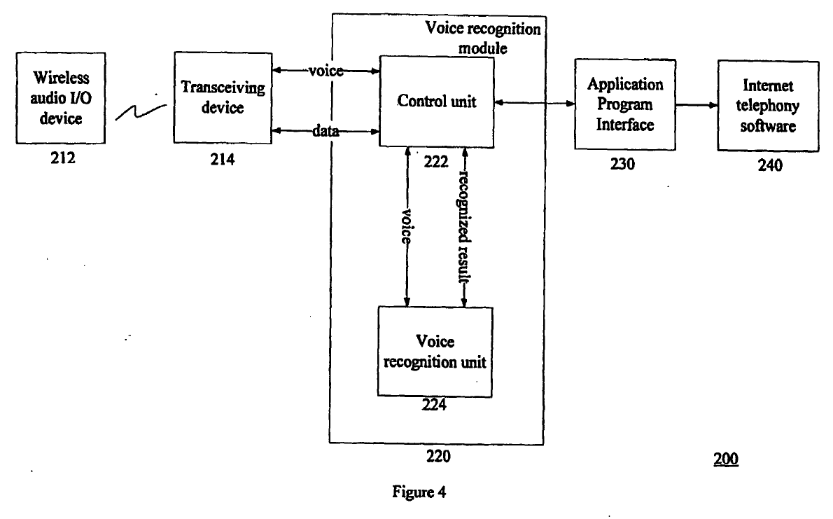

Please refer to FIG. 4. FIG. 4 is a block diagram of the apparatus 200 for making a voice connection according to another embodiment. The apparatus 200 comprises a wireless audio I/O device 212, a transceiving device 214, a voice recognition module 220, an Application Program Interface (API) 230, and network telephony software 240, wherein the voice recognition module 220 includes a control unit 222 and a voice recognition unit 224. In the present embodiment, the wireless audio I/O device 212 may be a Bluetooth handset for receiving or playing a voice information, and the transceiving device 214 may be a Bluetooth dongle plugged in the USB port of the user's computer for propagating data and voice information between the wireless audio I/O device 212 and the control unit 222. In the present embodiment, if the user would like to make a voice connection through the network, the user just needs to press the connection button on the Bluetooth handset and say the command, and then the voice information carrying the command is passed to the control unit 222 through the transceiving device 214.

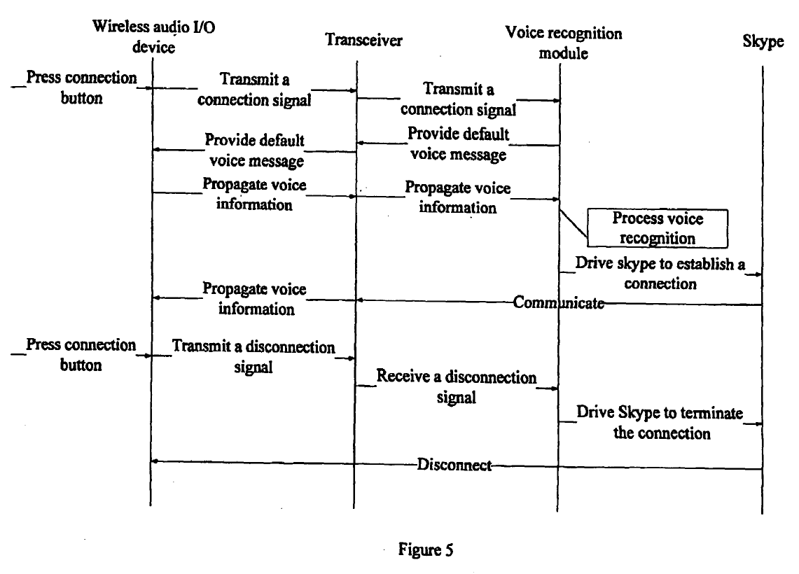

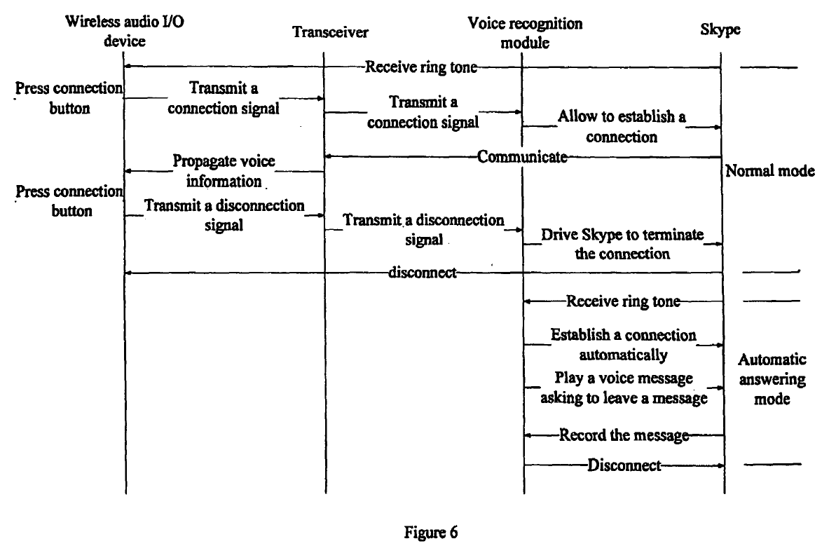

Since the functions of the voice recognition module 220, the Application Program Interface (API) 230, and the network telephony software 240 are the same as those of the devices having the same name depicted in FIG. 1, the functions thereof is not redundantly stated. FIG. 5 and FIG. 6 are flow charts of the dial-out procedure and the call-in procedure of the apparatus 200. They are also similar to those of FIG. 2 and FIG. 3, and are thus not redundantly stated.

It should be noted that the voice recognition modules 120 and 220 may be implemented by a circuit or a program comprising code segments. If the voice recognition module 120 or 220 is implemented by a circuit, it may be embedded in the transceiving device 214 or an interface card plugged in the computer. If the voice recognition module 120 or 220 is implemented by a program, it can be stored on a machine-readable medium and executed by a computer, a PDA, or other machines. Examples of a machine-readable medium include recordable-type medium such as a floppy disc, a hard disc drive, a RAM and CD-ROMs and transmission-type medium such as digital and analog communication links. Similarly, the above methods also can be implemented by a program stored on a machine-readable medium.

What is claimed is:

1. A telephony method comprising:
inputting a name of a desired party as spoken by a user;
performing machine recognition of the name;
determining whether the desired party is unreachable; and
unless the desired party is unreachable, commencing packet-based voice communications with the desired party.

2. The method of claim 1, comprising sending an audio representation of the name as spoken by the user.

3. The method of claim 2, comprising using instant messaging presence services to determine whether the desired party is unreachable.

4. The method of claim 3, wherein the desired party is considered unreachable if the desired party is not connected to a wired or wireless network.

5. The method of claim 4, wherein the desired party is considered unreachable if the desired party is not connected to a wired or wireless network selected from a group consisting of the internet, an intranet, a WLAN network and a WiMax network.

6. A telephony system comprising:
a telephony device coupled to an IP network; and
a wireless headset that, during operation, is wirelessly coupled to the telephony device;
the telephony device comprising:
a voice recognition unit for inputting a name of a desired party spoken by a user and performing machine recognition of the name; and
a voice instant messaging unit for determining whether the desired party is unreachable and, unless the desired party is unreachable, commencing packet-based voice communications with the desired party.

7. The apparatus of claim 6, wherein the voice instant messaging unit is configured to send an audio representation of the name as spoken by the user.

8. The apparatus of claim 7, wherein the voice instant messaging unit is configured to use instant messaging presence services to determine whether the desired party is unreachable.

9. The apparatus of claim 7, wherein the voice instant messaging unit is configured to determine that the desired party is unreachable if the desired party is not connected to a wired or wireless network.

10. The apparatus of claim 7, wherein the voice instant messaging unit is configured to determine that the desired party is unreachable if the desired party is not connected to a wired or wireless network wireless network selected from a group consisting of the internet, an intranet, a WLAN network and a WiMax network.

12. A telephony headset comprising:
a housing that, during use, is worn so as to produce sound in a user's ear; and
a touch sensor coupled to the housing to detect a touch of the user without the user pressing a button.

13. The apparatus of claim 12, comprising circuitry coupled to the touch sensor and responsive to the touch sensor detecting a touch of the user to perform audio input and wireless audio transmission.

14. A method of setting up a telephony device for telephony using a talk-to-talk interface, comprising:
for each of a plurality of contacts,
prompting a user to speak a name of the contact; and
storing voice information in correspondence to the contact for later comparison to an audio representation from another instance of the user speaking the name of the contact.

15. The method of claim 14, comprising prompting the user to speak the name of the contact multiple times with different inflections.
